(19) United States
(12) Patent Application Publication
(10) Pub. No.: US 2013/0046793 A1
(43) Pub. Date: Feb. 21, 2013

(54) FAST MATCHING OF IMAGE FEATURES USING MULTI-DIMENSIONAL TREE DATA STRUCTURES

(71) Applicants: Yuriy Reznik, Seattle, WA (US); Sundeep Vaddadi, San Diego, CA (US)

(72) Inventors: Yuriy Reznik, Seattle, WA (US); Sundeep Vaddadi, San Diego, CA (US)

(73) Assignee: QUALCOMM Incorporated, San Diego, CA (US)

(21) Appl. No.: 13/214,089

(22) Filed: Aug. 19, 2011

(51) Int. Cl. G06F 17/30

(52) U.S. Cl. 707/797; 707/E17.012

(57) ABSTRACT

A method for generating a descriptor tree data structure is provided. A plurality of descriptors are obtained for one or more images, each descriptor defined within a multi-dimensional descriptor space. The plurality of descriptors are partitioned into nodes of a tree data structure, where the number of nodes in such partitioning is a function of the number of descriptors in the plurality of descriptors. The nodes having more than two descriptors may be sub-partitioned into sub-nodes of the tree data structure until two or fewer descriptors remain per sub-node, where such sub-partitioning is a function of the number of descriptors remaining in each such node and/or a dimensionality of such descriptors.

### BACKGROUND

1. Field

The invention relates to computer vision, and more particularly, to methods and techniques for finding matches for given image features in a database.

2. Background

Various applications may benefit from having a machine or processor that is capable of identifying objects in a visual representation (e.g., an image or picture). The field of computer vision attempts to provide techniques and/or algorithms that permit identifying objects or features in an image, where an object or feature may be characterized by descriptors identifying one or more keypoints. These techniques and/or algorithms are often also applied to face recognition, object detection, image matching, panorama stitching, 3-dimensional structure construction, stereo correspondence, and/or motion tracking, among other applications. Generally, object or feature recognition may involve identifying points of interest (also called keypoints) in an image for the purpose of feature identification, image retrieval, and/or object recognition. Preferably, the keypoints may be selected and/or processed such that they are invariant to image scale changes and/or rotation and provide robust matching across a substantial range of distortions, changes in point of view, and/or noise and changes in illumination. Further, in order to be well suited for tasks such as image retrieval and object recognition, the feature descriptors may preferably be distinctive in the sense that a single feature can be correctly matched with high probability against a large database of features from a plurality of target images.

After the keypoints in an image are detected and located, they may be identified or described by using associated descriptors. For example, descriptors may represent the visual features of the content in the image, such as color, texture, rotation, scale, and/other characteristics. A descriptor may represent a keypoint and the local neighborhood around the keypoint. The goal of descriptor extraction is to obtain robust, noise resilient representation of the local information around keypoints.

The individual features corresponding to the keypoints and represented by the descriptors are matched to a database of features of known objects. Therefore, a correspondence searching system can be separated into three modules: keypoint detector, feature descriptor, and correspondence locator. In these three logical modules, the descriptor's construction complexity and dimensionality have direct and significant impact on the performance of the feature matching system.

Such feature descriptors are increasingly finding applications in real-time object recognition, 3D reconstruction, panorama stitching, robotic mapping, video tracking, and similar tasks. Depending on the application, transmission and/or storage of feature descriptors (or equivalent) can limit the speed of computation of object detection and/or the size of image databases. In the context of mobile devices (e.g., camera phones, mobile phones, etc.) or distributed camera networks, significant communication and processing resources may be spent in descriptors extraction and matching operations. The computationally intensive processes of descriptor extraction and matching tend to hinder or complicate its application on resource-limited devices, such as mobile phones.

In the original SIFT implementation (Object Recognition From Local Scale-Invariant Features, Proceedings of the International Conference on Computer Vision, Vol. 2, pp. 1150-1157), David Lowe suggested using k-d trees to perform the search. K-dimensional trees are essentially k-dimensional generalizations of standard binary search trees. (See J. L. Bentley, Multidimensional Binary Search Trees Used for Associative Searching, Communications of the ACM, 18(9):509-517, 1975, and J. H. Friedman, J. L. Bentley, and R. A. Finkel, An Algorithm for Finding Best Matches in Logarithmic Expected Time. ACM Trans. Math. Softw. 3, 3, 209-226, 1977). It is well known that k-dimensional trees (k-d trees) fundamentally require a logarithmic number of operations (with respect to the size of the database) to perform a search. It is also known that k-d trees are naturally suitable to find nearest (feature) matches in L-infinity metric, and their use for fast search using other metrics is more complicated.

So-called “vocabulary trees” is another example of a prior art algorithm which is based on tree-structured quantization of the space containing set of features in the database. It can be optimal for broad range of distance metrics, but it is computationally complex (finding nearest match at each level is an exhaustive search operation). The term “vocabulary trees” for computer vision implementations is discussed by: D. Nister and H. Stevenius, Scalable Recognition with a Vocabulary Tree, IEEE Conference for Computer Vision and Pattern Recognition (CVPR) 2006.

Both k-d trees and vocabulary trees use some fixed cardinality (say K) of their nodes, which implies that the search time will be logarithmic with respect to the size of the database being searched. Therefore, a method is needed to reduce the logarithmic search time for matches in a descriptor database.

### SUMMARY

The following presents a simplified summary of one or more embodiments in order to provide a basic understanding of some embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A method for generating a descriptor tree data structure is provided. A plurality of descriptors is obtained for one or more images, where each descriptor is defined within a multi-dimensional descriptor space. For instance, the multi-dimensional descriptor space may be a bounded, k-dimensional value space, where k is an integer greater or equal to two.

The plurality of descriptors is then partitioned into nodes of a tree data structure, where the number of nodes in such partitioning is a function of the number of descriptors in the plurality of descriptors. The descriptors may be representative of local features in an image.

The nodes having more than two descriptors are then sub-partitioned into sub-nodes of the tree data structure until two or fewer descriptors remain per sub-node, where such sub-partitioning is a function of the number of descriptors remaining in each such node. The descriptor tree data structure may be stored for subsequent use in descriptor matching. For instance, a query descriptor for a query image may be subsequently obtained. The tree data structure is then iteratively traversed by progressively selecting nodes encompassing the query descriptor until a final node is reached. One or more descriptors are selected in the final node as a match with the query descriptor.

Such partitioning and sub-partitioning may also be a function of a dimensionality of such descriptors. For instance, for 2-dimensional descriptors the partitioning and sub-partitioning is based on a square root of the number of descriptors for a particular node. In another example, for 3-dimensional descriptors the partitioning and sub-partitioning is based on a cubic root of the number of descriptors for a particular node. In a general example, for k-dimensional descriptors the partitioning and sub-partitioning is based on a k-th root of the number of descriptors for a particular node, where k is an integer greater than or equal to four.

In one example, the partitioning and/or sub-partitioning may be based on a non-linear function. For instance, for a k-dimensional descriptor space, a number of partitions G_{N} when N descriptors are present is given by G_{N}=floor(kth-root(N)+0.5).

Similarly, a device is provided for generating a descriptor tree data structure. The device may include a storage device and a processing circuit. The storage device may be adapted to store a descriptor tree data structure. The processing circuit may be adapted to: (a) obtain a plurality of descriptors for one or more images, each descriptor defined within a multi-dimensional descriptor space; (b) partition the plurality of descriptors into nodes of a tree data structure, where the number of nodes in such partitioning is a function of the number of descriptors in the plurality of descriptors; (c) sub-partition nodes having more than two descriptors into sub-nodes of the tree data structure until two or fewer descriptors remain per sub-node, where such sub-partitioning is a function of the number of descriptors remaining in each such node. Such partitioning and sub-partitioning may also be a function of a dimensionality of the multi-dimensional descriptor space; (d) obtain a query descriptor for a query image; (e) iteratively traverse the tree data structure by progressively selecting nodes encompassing the query descriptor until a final node is reached; and/or (f) select one or more descriptors in the final node as a match with the query descriptor.

A method for descriptor matching is also provided. A tree data structure is obtained including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space. The plurality of descriptors may be obtained from one or more images to build the tree data structure. Nodes having more than two descriptors are sub-partitioned into sub-nodes until two or fewer descriptors remain per sub-node, where such sub-partitioning is a function of the number of descriptors remaining in each such node. The plurality of descriptors in the tree data structure may be partitioned as a function of a dimensionality of such descriptors. A query descriptor may be obtained for a query image. The tree data structure is iteratively traversed by progressively selecting nodes encompassing the query descriptor until a final node is reached. One or more descriptors may be selected in the final node as a match with the query descriptor. For k-dimensional descriptors, the partitioning of the plurality of descriptors of the tree data structure may be based on a k-th root of the number of descriptors for a particular node, where k is an integer greater than or equal to two.

A device for descriptor matching is also provided. The device may include a storage device and a processing circuit. The storage device may be adapted to store a descriptor tree data structure. The processing circuit may be adapted to: (a) obtain a tree data structure including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space; (b) obtain a query descriptor for a query image; (c) iteratively traverse the tree data structure by progressively selecting nodes encompassing the query descriptor until a final node is reached; and/or (d) select one or more descriptors in the final node as a match with the query descriptor.

### BRIEF DESCRIPTION OF THE DRAWINGS

Various features, nature, and advantages may become apparent from the detailed description set forth below when taken in conjunction with the drawings in which like reference characters identify correspondingly throughout.

FIG. 1 is a block diagram illustrating the functional stages for performing object recognition.

FIG. 2 illustrates a binary tree structure.

FIG. 3 illustrates an exemplary implementation of a binary search tree operating with real values in the range [0,1) instead of strings.

FIG. 4 illustrates an extension of the tree structure of FIG. 2 that is obtained by allowing more than one symbol of the input alphabet to be used for branching.

FIG. 5 illustrates an example of a tree structure that adaptively selects its branching factors.

FIG. 6 illustrates an exemplary implementation of an N-tree.

FIG. 7 illustrates a 2-dimensional k-d tree constructed over a set of points.

FIG. 8 shows a corresponding space partition diagrams for the 2-dimensional K-d tree in FIG. 7.

FIG. 9 illustrates an adaptive multi-dimensional tree constructed by partitioning each node as a function of the number of points that remain in the sub-tree for that node.

FIG. 10 shows a corresponding space partition diagrams for the 2-dimensional k-d tree in FIG. 9.

FIG. 11 illustrates a method for arranging and/or partitioning k-dimensional data (e.g., sample points, values, etc.) into N-tree.

FIG. 12 is a block diagram illustrating an example of a device that may generate a keypoint descriptor database.

FIG. 13 is a flow diagram illustrating a method for building a descriptor database.

FIG. 14 is a diagram illustrating how a descriptor may be searched in a database constructed from a 2-dimensional k-d tree that maps a plurality of descriptor points to a set of nodes.

FIG. 15 is a flow diagram illustrating a method for finding a descriptor match in a descriptor database.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

### Overview

One feature provides a way to improve the search time of feature descriptors (e.g., and other types of data) stored in a multi-dimensional tree data structure by partitioning a value space as a function of the number of values/points remaining in the value space and/or the dimensionality of the value space. That is, a plurality of N k-dimensional values (e.g., feature descriptors for an image) is obtained within a value space (e.g., bounds of an image). The N k-dimensional values are stored in a k-dimensional tree structure, where a first level of nodes represent sub-regions of the value space that have been subdivided as a function of the k dimensions and/or the N number of values. Then, for each node having more than two points remaining, such sub-region is further subdivided in k-dimensions into equal area sub-regions. Thus, a second level of nodes may be created within the multi-dimensional tree structure, each node in the second level representing the point(s) in a sub-region.

### Exemplary Object Recognition Process

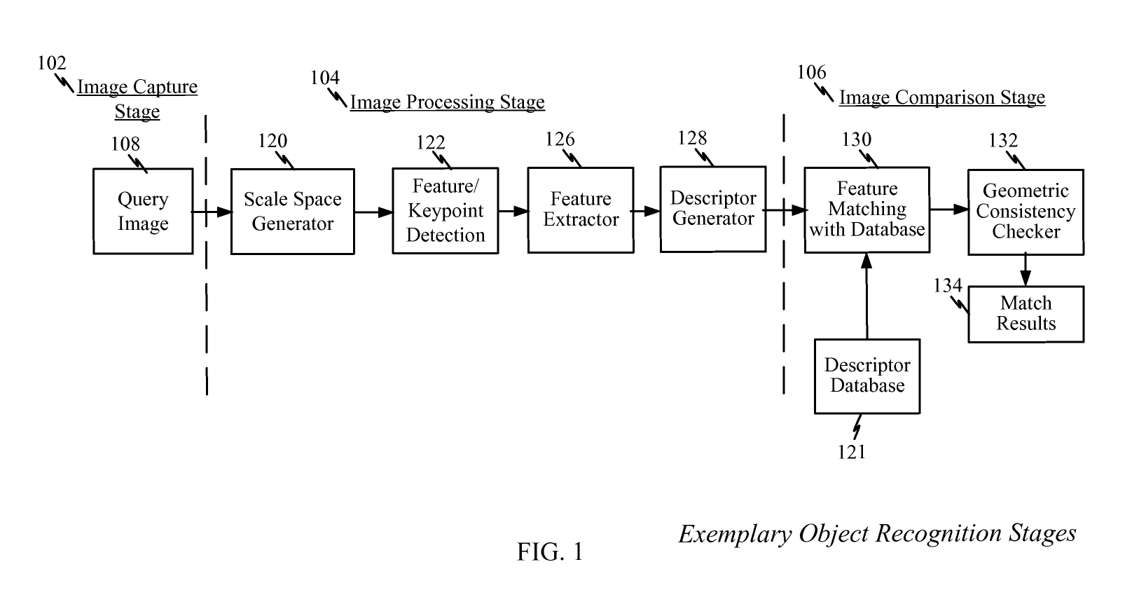

FIG. 1 is a block diagram illustrating the functional stages for performing object recognition. At an image capture stage 102, a query image 108 may be captured or otherwise obtained. For examples, the query image 108 may be captured by an image capturing device, which may include one or more image sensors and/or an analog-to-digital converter, to obtain a digital captured image. The image sensors (e.g., charge coupled devices (CCD), complementary metal semiconductors (CMOS)) may convert light into electrons. The electrons may form an analog signal that is then converted into digital values by the analog-to-digital converter. In this manner, the image 108 may be captured in a digital format that may define the image I(x, y), for example, as a plurality of pixels with corresponding color, illumination, and/or other characteristics.

In an image processing stage 104, the captured image 108 is then processed by a scale space generator 120 (e.g., Gaussian scale space), a feature/keypoint detector 122, a sparse feature extractor 126, and a descriptor generator 128. At an image comparison stage 106, the query descriptors 128 are used to perform feature matching 130 with the database of known descriptors 121 associated with previously processed images. A geometric verification or consistency checker 132 may then be applied on keypoint matches (e.g., based on matching descriptors) to ascertain correct feature matches and provide match results 134. In this manner, a query image may be compared to, and/or identified from, a descriptor database 121. Note that the descriptor database 121 may be built by obtaining a plurality of images and processing them through the images processing stages 104.

In order to efficiently search for a descriptor match, e.g., in the feature matching with database stage 130, the descriptors in the descriptor database 121 may be arranged in a tree data structure that facilitates computerized, automated searching. However, the descriptor database 121 may increase or decrease in size, so there is a need for such data structure to be able to accommodate such addition or removal of descriptors, preferably without the need to rearrange or rebuild the whole tree data structure.

### Exemplary 1—Dimensional Digital Trees

Digital trees (also known as radix search trees, or tries) represent a convenient way of organizing alphanumeric sequences (strings) of variable lengths that facilitates their fast retrieving, searching, and sorting. A set of n distinct strings may be defined as S={s1, . . . , sn}, and each string may have a sequence of symbols from a finite alphabet Σ={α1, . . . , αv}, |Σ|=v, then a trie T(S) over S can be constructed recursively as follows. If n=0, the trie T(S) is an empty external node. 2 If n=1 (i.e. S has only one string), the trie is an external node containing a pointer to this single string in S. If n>1, the trie is an internal node containing v pointers (or branches) to the child tries: T(S1), . . . , T (Sv), where each set Si (1≦i≦v) contains suffixes of all strings from S that begin with a corresponding first symbol.

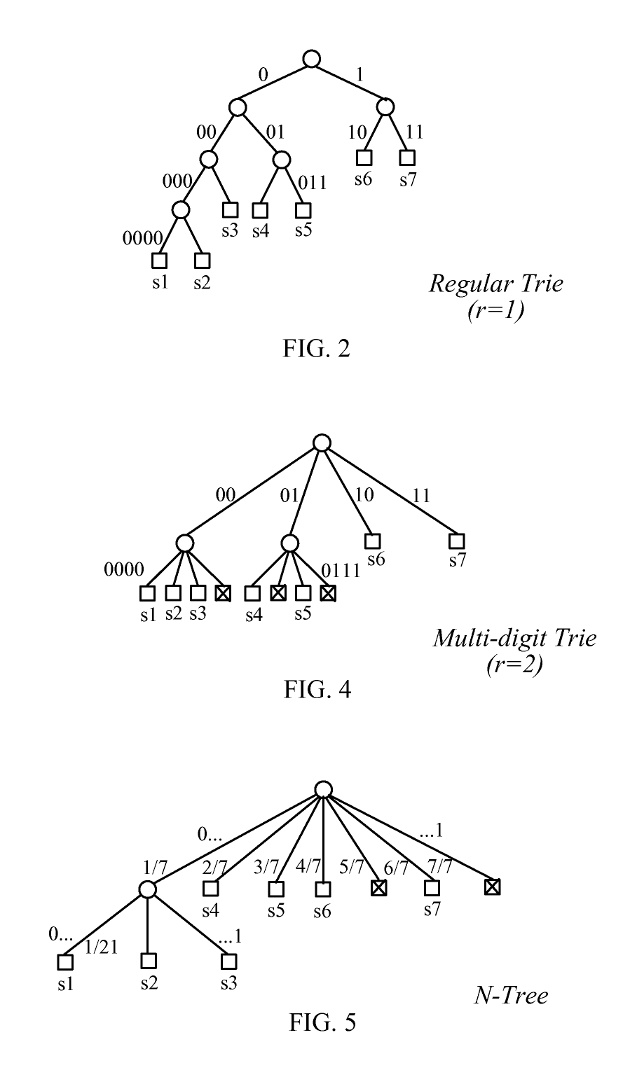

FIG. 2 illustrates a binary tree structure. If a string sj=uj wj (uj is a first symbol, and wj is a string containing the remaining symbols of sj), and uj=αi, then the string wj will go into Si. Thus, after all child tries T(S1), . . . , T(Sv) are recursively processed, a tree-like data structure (as in FIG. 2) is obtained where the original strings S={s1, . . . , sn} can be uniquely identified by the paths from the root node to non-empty external nodes. In this example, the tries may be built for 7 binary strings: s1=0000 . . . , s2=0001 . . . , s3=0010 . . . , s4=0100 . . . , s5=0110 . . . , s6=100 . . . , s7=110 . . . . Each such string may be representative of a feature descriptor, for example.

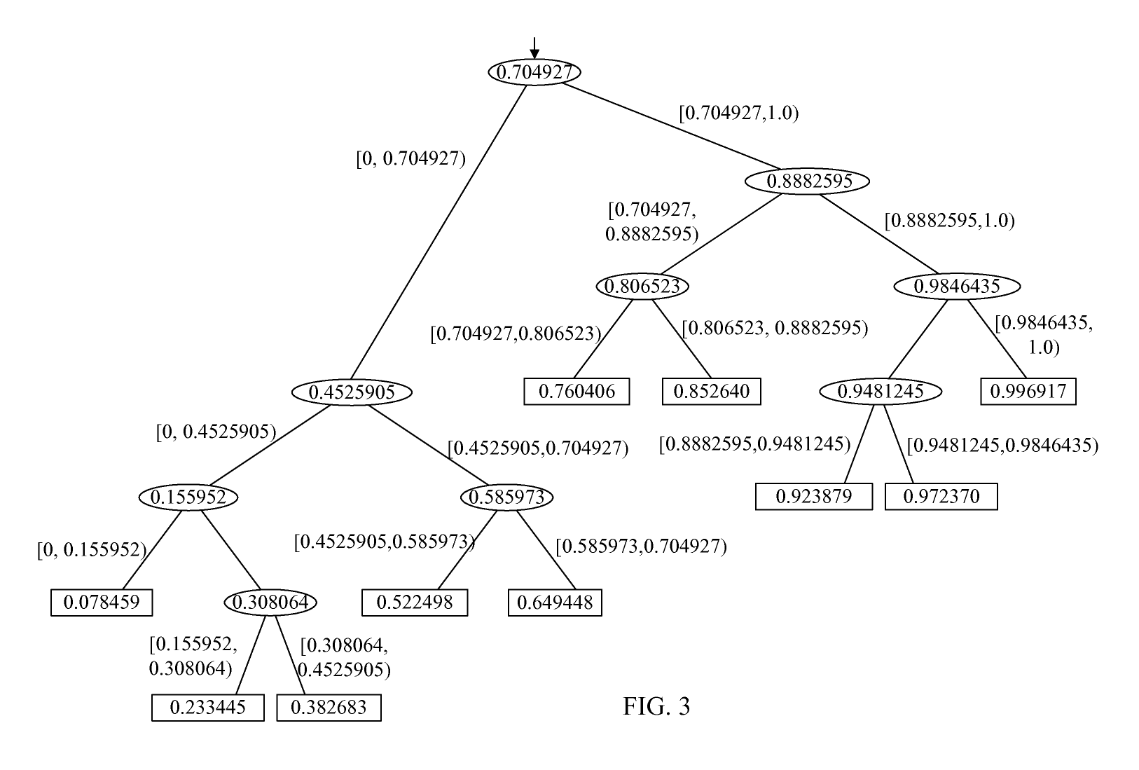

FIG. 3 illustrates an exemplary implementation of a binary search tree operating with real values in the range [0,1) instead of strings. In this example, the digital tree has the following values inserted: s1=0.07845909574, s2=0.2334453638, s3=0.3826834325, s4=0.5224985647, s5=0.6494480484, s6=0.7604059656, s7=0.8526401647, s8=0.9238795325, s9=0.9723699205, and s10=0.9969173338. In order to implement the branching process, this tree stores intermediate “threshold” values in each node. For example, the root node sets threshold 0.704927, implying that all values that are less will be inserted in the left subtree, and values that are greater or equal will be inserted in the right subtree.

FIG. 4 illustrates an extension of the tree structure of FIG. 2 that is obtained by allowing more than one symbol of the input alphabet to be used for branching. Thus, if a trie uses some constant number of symbols r≧1 per lookup, then the effective branching coefficient is equal to v^{r}, and this is essentially a trie built over an alphabet of r symbols. To underscore the fact that branching is implemented using multiple input symbols (digits) at a time, such tries are sometimes called multi-digit tries.

The behavior of regular tries is thoroughly analyzed. For example, it has been shown that the expected number of nodes examined during a successful search in a v-ary trie is asymptotically log(n)/h+O(1), where h is the entropy of a process used to produce n input strings. The expected size of such trie is asymptotically nv/h+O(1), where n is the number of strings inserted, v is the cardinality of each node, and h is the entropy of the source. These estimates are known to be correct for a rather large class of stochastic processes, including memoryless, Markovian, and mixed models.

Much less known are modifications of tries that use adaptive branching. That is, instead of using nodes of some fixed degree (e.g., matching the cardinality of an input alphabet), adaptive tries select branching factors dynamically, from one node to another.

FIG. 5 illustrates an example of a tree structure that adaptively selects its branching factors. This particular tree structure is known as N-tree (cf. G. Ehrlich, Searching and Sorting Real Numbers, J. Algorithms, 2, pp. 1-14, 1981) and it is also central to the concept of sorting by distribution (cf. W. Dobosiewitz, Sorting by Distributive Partitioning, Inform. Process. Lett. 7 (1), pp. 1-6, 1978). The N-tree construction algorithm selects the degrees of nodes to be equal exactly the number of strings inserted in the sub-tries they originate. For example, the N-tree in FIG. 5 contains seven strings overall, and therefore its root node has seven branches. In turn, its first branch receives three strings s1, s2, and s3 to be inserted, and thus the N-tree creates a node with three additional branches, and so on.

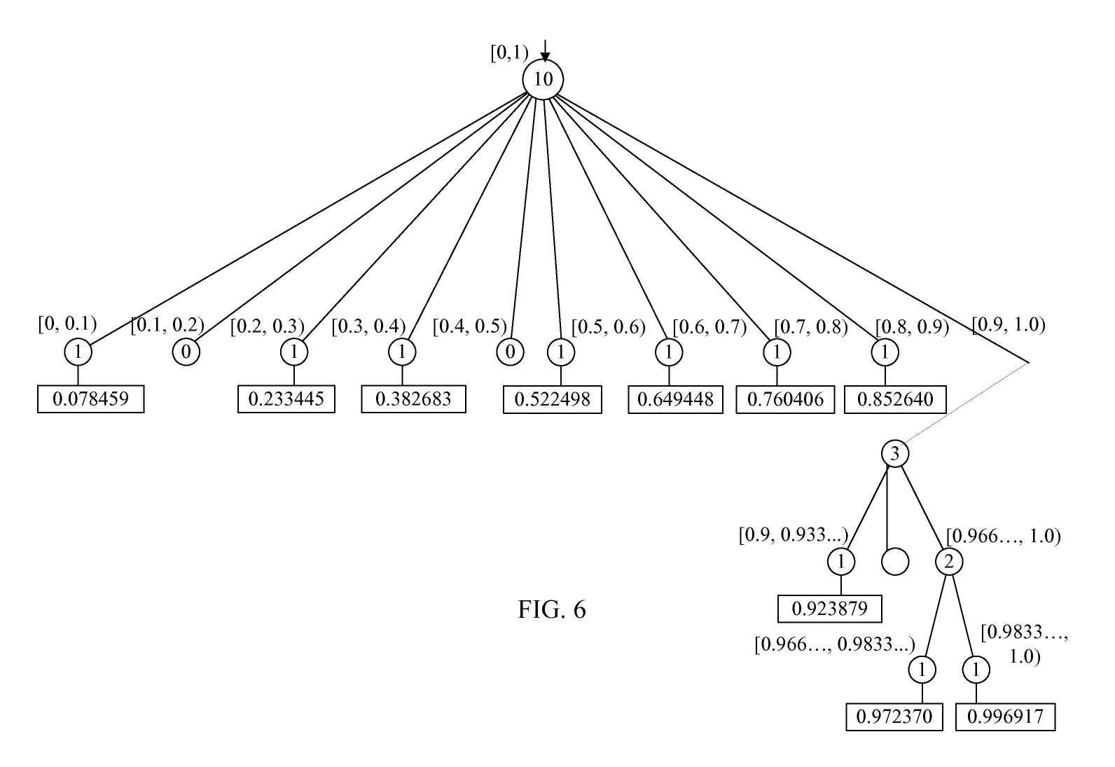

FIG. 6 illustrates an exemplary implementation of an N-tree. This is an illustration of the N-tree search tree structure of FIG. 5 but using 10 strings, e.g., real values in the interval [0, 1). In this example, the digital tree has the following strings: s1=0.078459, s2=0.233445, s3=0.382683, s4=0.522498, s5=0.649448, s6=0.760406, s7=0.852640, s8=0.923879, s9=0.972370, and s10=0.996917. In the case of N-trees, the interval (initially [0,1)) is split into N partitions, and branching is done by computing the index of the next branch as follows:

next_branch_index=floor((value−left_bound)*N);

and
updates of the interval are as follows:

next_left_bound=left_bound+next_branch_index*range/N;

next range=range/N.

where “value” is the thing that we want to find, N represents the number of values inserted in the subtree, “left_bound” is the left boundary of the current interval ([0,1) initially), and “range” is the width of the interval.

From FIG. 6, it can be observed that the N-tree is much flatter than the binary tree of FIG. 4 and that most values become separated right at the first step (node). It is known, that, on average, only a constant number of steps (practically 2-3 steps) is needed to find values, regardless of the size of the database. This is why they are appealing as search structure. Only numbers of remaining values (parameters N) need to be stored in nodes in order to implement N-trees.

While N-trees have extremely appealing theoretical properties (e.g., N-trees attain a constant (O(1)) expected search time, and use a linear (O(n)) amount of memory), there are several important factors that limit their practical usage (e.g., for purposes of organizing, sorting and/or searching feature descriptors). One significant problem is that the N-tree is not a dynamic data structure. It is more or less suitable for a multi-pass construction when all n strings are known, but any addition or removal of a string in an existing N-tree structure is rather problematic. In the worst case, such an operation may involve the reconstruction of the entire N-tree, making the cost of its maintenance extremely high. Somewhat more flexible is a B-b parameterized version of an N-tree (cf. W. Dobosiewitz, The Practical Significance of DP Sort Revisited, Inform. Process. Lett. 8 (4), pp. 170-172, 1979). This algorithm selects the branching factors to be equal n=b (b≧1), and split child nodes only when the number of strings there becomes larger than B. When both B and b are equal to one (1), this is a normal N-tree. However, when B and b are large, the complexity of updates can be substantially reduced. In practice, B and b parameters are usually chosen empirically, based on the size of the database and relative frequencies of search and update operations.

### Exemplary 2—Dimensional Digital Trees

A multi-dimensional tree (also known as a k-dimensional tree or k-d tree) is a space-partitioning data structure for organizing points in a k-dimensional space. K-dimensional trees are a useful data structure for several applications, such as searches involving a multi-dimensional search string.

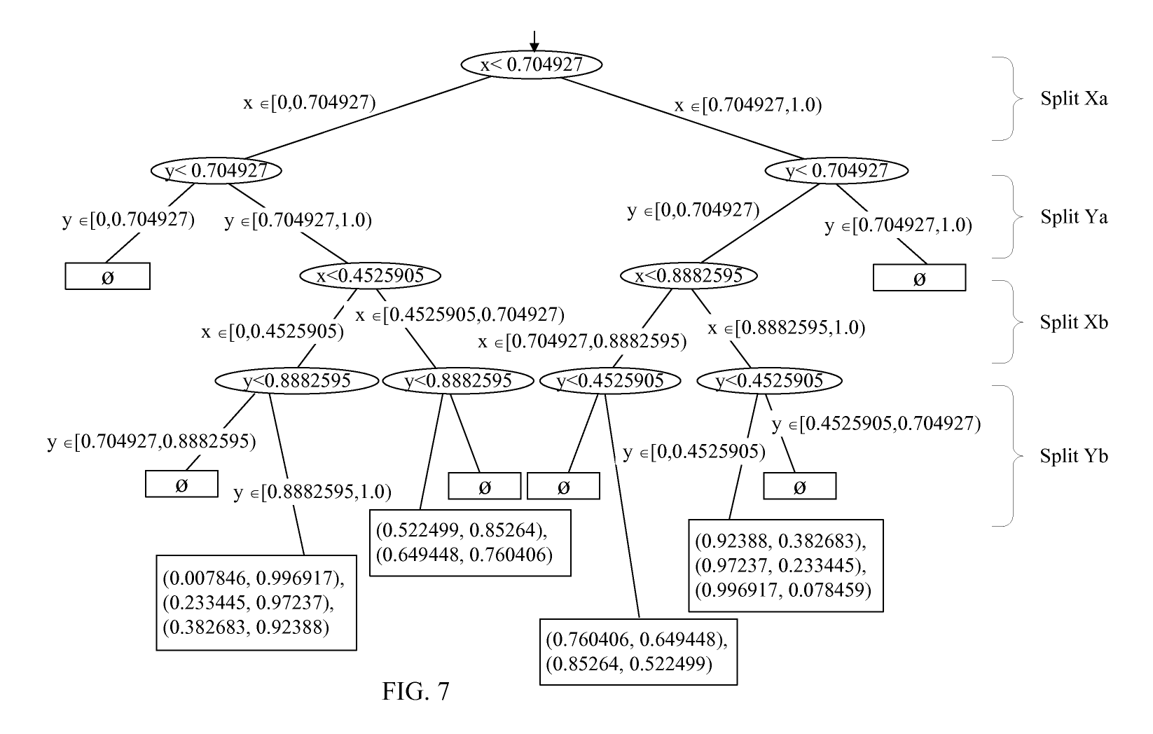

FIG. 7 illustrates a 2-dimensional k-d tree constructed over a set of points. In this illustration, the set of points may be found in a space of values given by a two-dimensional region, e.g., a unit square: (0,1)×(0,1). In this example, strings (e.g., descriptors) to be stored in a database are represented by a plurality of points within this space. For instance, ten such exemplary strings may be represented by points P1:(0.0078459, 0.996917), P2:(0.233445, 0.97237), P3:(0.382683, 0.92388), P4:(0.522499, 0.85264), P5:(0.649448, 0.760406), P6:(0.760406, 0.649448), P7:(0.85264, 0.522499), P8:(0.92388, 0.382683), P9:(0.97237, 0.233445), and P10:(0.996917, 0.078459). In this example, each point P, may be representative of a string (or descriptor). While this example illustrates that each string (or descriptor) may be represented by two point values (x and y), other implementations may represent each string (or descriptor) with a fewer or greater number of values. Note that the use of x and y orientations to represent a point P, is merely used to illustrate the concept of mapping a string (or descriptor) to a value space and need not actually represent a location in which a string (or descriptor) occurs.

As can be perceived from this example, up to four (4) decisions (at splits Xa, Ya, Xb, and Yb) must be made to search for a particular point. First, a decision is made to segment points along the x-orientation, so that points along the x-orientation fall within either xε[0, 0.704927) or xε[0.704927,1.0). Then, a second decision is made to segment points along the y-orientation, so that points along the y-orientation fall within either yε[0, 0.704927) or yε[0.704927,1.0). In a third stage, a decision is made to segment points along the x-orientation, so that points along the x-orientation fall within either xε[0,0.4525905), xε[0.4525905,0.704927), xε[0.704927,0.8882595), or xε[0.8882595,1.0). In a fourth stage, a decision is made to segment points along the x-orientation, so that points along the x-orientation fall within either yε[0,0.4525905), yε[0.4525905,0.704927), y E [0.704927,0.8882595), or yε[0.8882595,1.0).

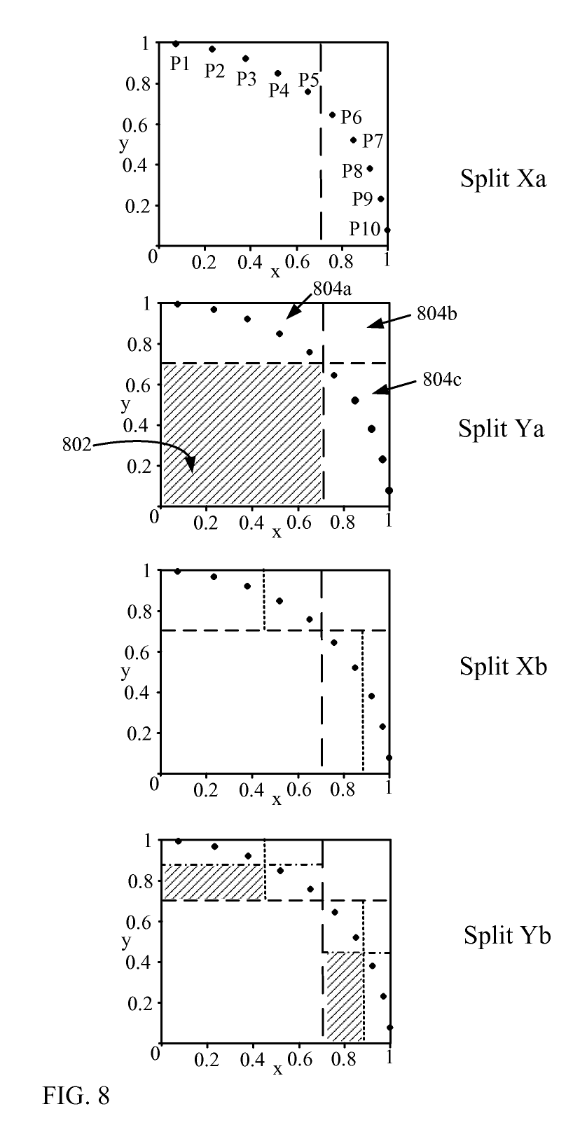

FIG. 8 shows a corresponding space partition diagrams for the 2-dimensional k-d tree in FIG. 7. At each split Xa, Ya, Xb, and Yb, the value space is subdivided, meaning a decision is being made at a node. In this example, a first split Xa occurs at x=0.704927. Then, a second split occurs at y=0.704927. At this stage, the value space has been subdivided in half, into a first region 802 and a second region 804 (comprising sub-regions 804a, 804b, and 804c). This process may continue to subdivide each sub-region 804a and 804c in half (at splits Xb and Yb). It can be observed that parsing each node corresponds to halving the space to be searched along one of the dimensions. Consequently, this parsing process has logarithmic depth. In this example, the decision process traverses through four (4) lookups of the k-d tree (FIG. 7).

### Improved Multi-Dimensional Tree Construction For Fast Matching

To reduce the search time in a k-dimensional tree, one approach herein provides for partitioning a value space as a function of the dimensionality of the value space and the number of values/points in the value space. The values/points are arranged across nodes of an N-tree. Each node with more than two values/points is further subdivided as a function of the dimensionality of the values and/or the number of values remaining within the node.

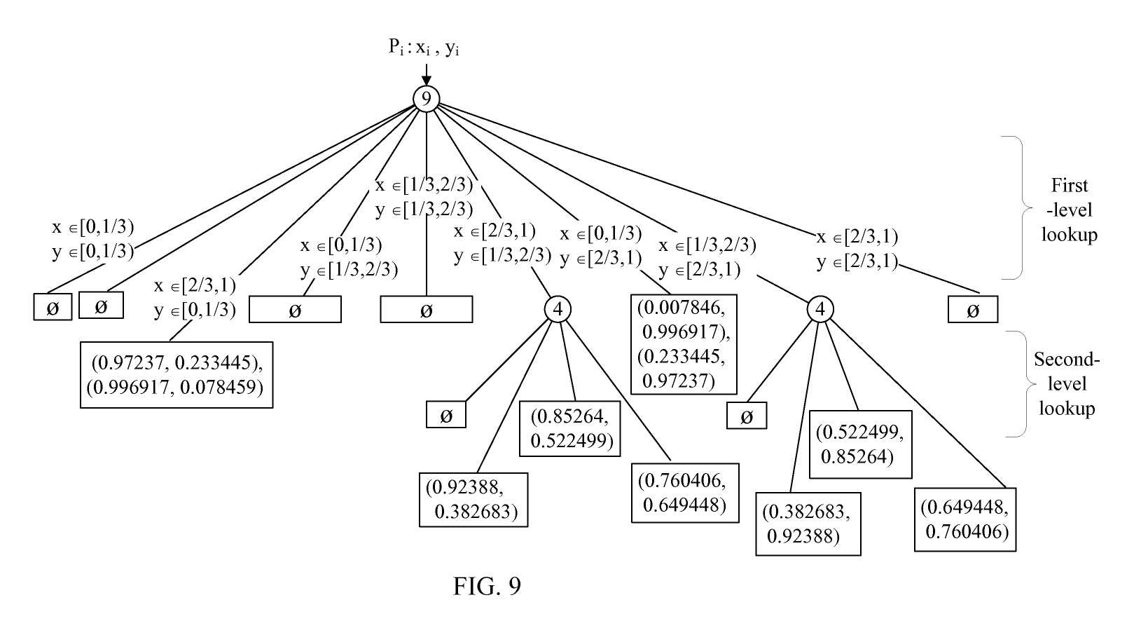

FIG. 9 illustrates an adaptive multi-dimensional tree constructed by partitioning each node as a function of the number of points that remain in the sub-tree for that node. An N-tree can be generalized to work with 2-dimensional and higher-dimensional data. This example uses the same ten exemplary sample points/values as in FIG. 7, P1:(0.0078459, 0.996917), P2:(0.233445, 0.97237), P3:(0.382683, 0.92388), P4:(0.522499, 0.85264), P5:(0.649448, 0.760406), P6:(0.760406, 0.649448), P7:(0.85264, 0.522499), P8:(0.92388, 0.382683), P9:(0.97237, 0.233445), and P10:(0.996917, 0.078459).

As with conventional N-trees, the nodes may include counters of values/points (N) remaining in each sub-tree (e.g., values/points remaining below that node in the tree). At each node, the tree construction/parsing algorithm then calculates the number of partitions G_{N} to make along each dimension. For example, in 2-dimensional case, it can be computed as follows: G_{N}=floor (square_root(N)+0.5). For the instance where N=10, then G_{N}=3 and the number of cells (sub-regions) created are G_{N}²=3²=10 cells. In higher number of dimensions (say k), this equation involves taking a root of k-th order such that the number of partitions G_{N} in each of the dimensions is a function of the values/points N remaining in a sub-tree (e.g., G_{N}=floor(k-th_root(N)+0.5)). If G_{N} is less than 2, the process is terminated (i.e., the last node in the tree has been reached). Otherwise, intervals corresponding to each coordinate are split into G_{N} sub-intervals, and N input strings are inserted into G_{N}² cells obtained by such partitioning. Note that the partitions G_{N} may be a non-linear function (e.g., square root, cube root, quad root, k-th-root, etc.).

In this example, in a first segmenting stage, a decision is made to segment points along the x-orientation and the y-orientation, so that points fall within regions xε[0,⅓), yε[0,⅓); xε[0,⅓), yε[⅓,⅔); xε[0,⅓), yε[⅔,1); xε[⅔,1), yε[0,⅓); xε[⅔,1), yε[⅓,⅔); or xε[⅔,1), yε[⅔,1).

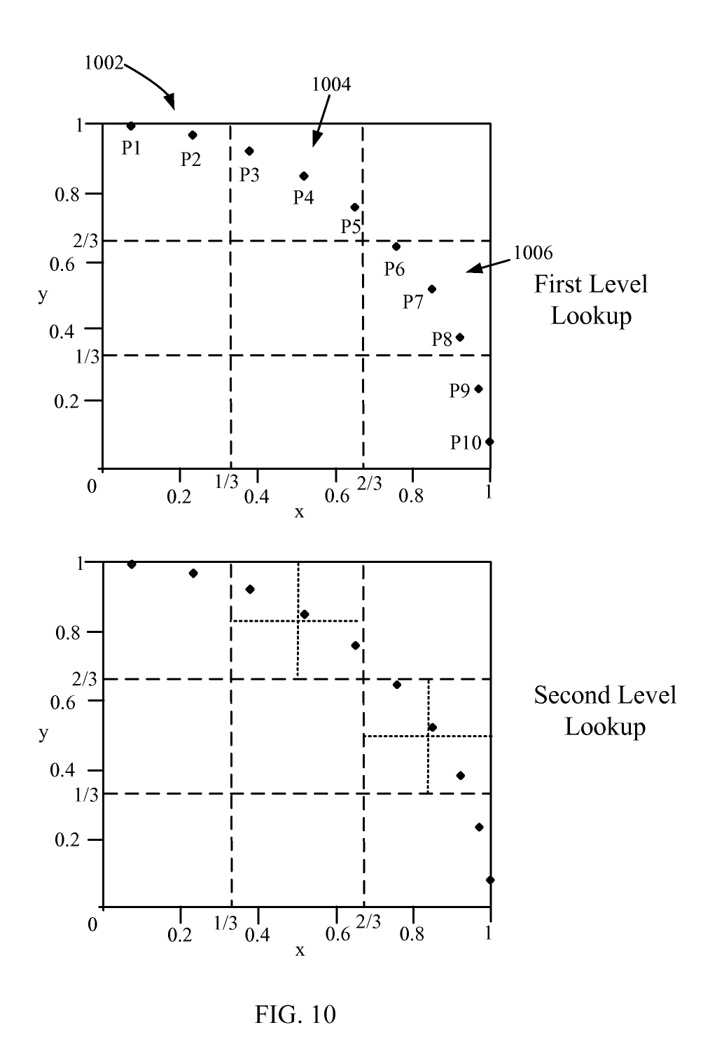

FIG. 10 shows a corresponding space partition diagrams for the 2-dimensional k-d tree in FIG. 9. As with one-dimensional N-trees, it can be observed that a first node effectively separates most of the values/points, and just a few extra lookups are needed to split the remaining value/point clusters. In this example, where ten (10) sample values/points (N=10) are initially considered within the value space 1002, the number of partitions G_{N} made along each dimension (e.g., x and y dimensions) of the value space 1002 is a function of the number of points in the value space 1002. For instance, the initial number of partitions G_{N} is given as G_{N}=₁₀=floor (square_root(10)+0.5)=3. This results G_{N}² cells or 9 cells/nodes. After this initial partitioning, two cells 1004 and 1006 each have three point/values such that G_{N} (for each of those two cells) is greater than 2 (G_{N}=₃=floor (square_root(3)+0.5)=2.7. Since these cells 1004 and 1006 have a G_{N}>2, they are sub-partitioned again to create a second lookup level where each sub-cell of the cells 1004 and 1006 have a G_{N}<2.

On average, the tree structure obtained by this type of partitioning (as in FIGS. 9 and 10) is constant in depth, therefore achieving dramatic reduction in search time as compared with conventional tree-based techniques (of FIGS. 7 and 8).

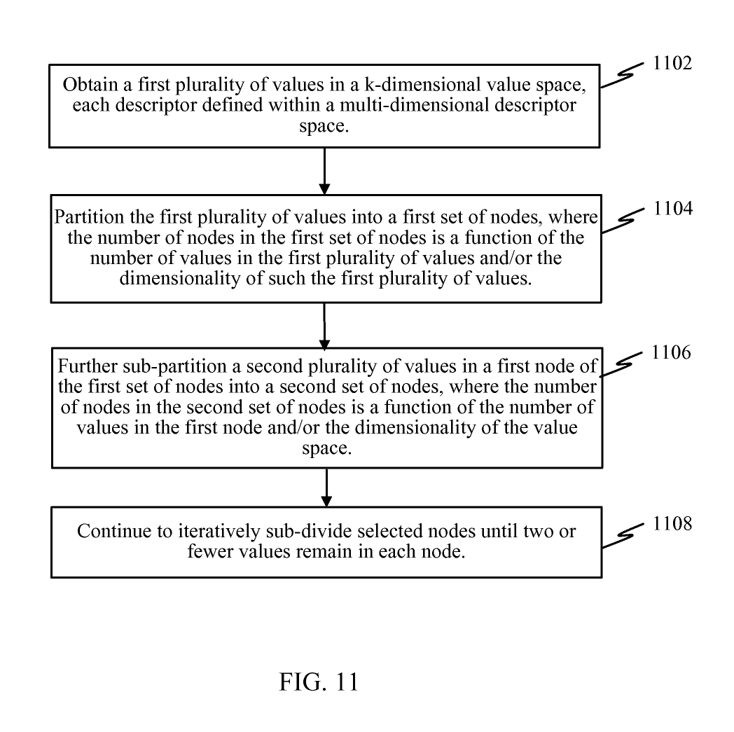

FIG. 11 illustrates a method for arranging and/or partitioning k-dimensional data (e.g., sample points, values, etc.) into N-tree. A first plurality of values is obtained where the first plurality of values fall within a k-dimensional value space 1102. The first plurality of values is partitioned (e.g., divided, segmented, or quantized) into a first set of nodes, where the number of nodes in the first set of nodes is a function of the number of values in the first plurality of values and/or the dimensionality of such the first plurality of values 1104. A second plurality of values in a first node of the first set of nodes may be further subdivided into a second set of nodes, where the number of nodes in the second set of nodes is a function of the number of values in the first node and/or the dimensionality of the value space 1106. This process may be repeated to iteratively subdivide selected nodes until two or fewer values remain in each node 1108. Note that the sub-division of a node may be proportional to the dimensionality of the values and/or the number of values remaining within the node. For instance, for N two-dimensional values (e.g., x, y), the value space may be subdivided as: G_{N}=floor (square_root(N)+0.5). For N three-dimensional values (e.g., x, y, z), the value space may be subdivided as: G_{N}=floor (cubic_root(N)+0.5). For N four-dimensional values (e.g., x, y, z, t), the value space may be subdivided as: G_{N}=floor (quad_root(N)+0.5). This may be extended to k-dimensional values such that, for N k-dimensional values (e.g., x, y, z, t, i, j, . . . ), the value space may be subdivided as: G_{N}=floor (k-th_root(N)+0.5).

Using the tree structure and methodology illustrated in FIGS. 9, 10, and 11, one or more descriptors for one or more images may be mapped to corresponding nodes of a k-d tree. Having constructed such k-d tree to represent a plurality of descriptors (e.g., for one or more image), the k-d tree may be subsequently used to find a closest match for a query descriptor.

In various implementations, partitioning of the value space and mapping into a tree data structure may be performed such that the value space is recursively divided into a cells of approximately equal size. Many standard lattices may be used to generate such partitions, including Aₙ, Dₙ, and Zₙ lattices for example (cf. J. H. Conway and N. J. A. Sloane, Sphere Packings, Lattices and Groups, Springer, 3rd edition, Dec. 7, 1998).

### Exemplary Keypoint Descriptor Database Generator Device

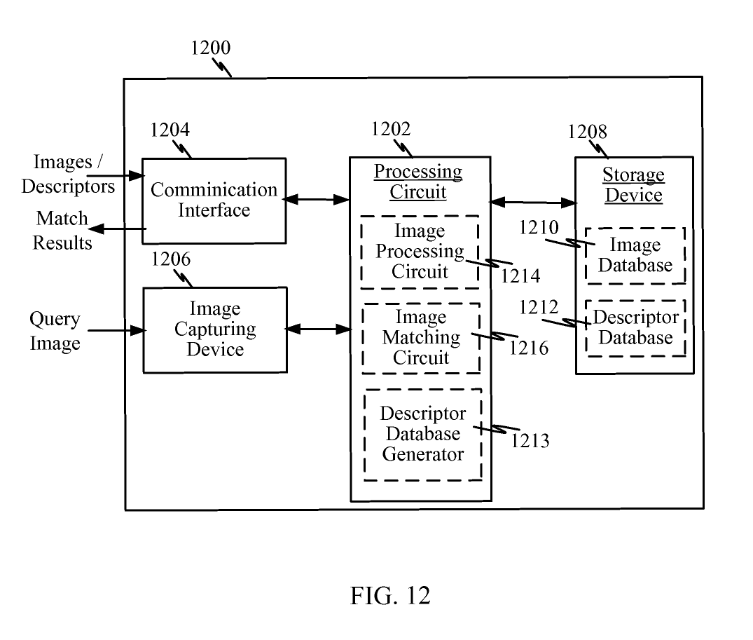

FIG. 12 is a block diagram illustrating an example of a device that may generate a keypoint descriptor database. The device 1200 may include a processing circuit 1202, coupled to a communication interface 1204, an image capturing device 1206, and/or a storage device 1208. The communication interface 1204 may be adapted to communicate over a wired/wireless network and receive images and/or feature descriptors for one or more images. The image capturing device 1206 may be, for example, a digital camera that can capture a query image. The processing circuit 1202 may include an image processing circuit 1214 to extract features from images and an image matching circuit 1216 that uses the extracted features to match a query image to a database of target images 1210 and/or query image descriptors to a descriptor database 1212. The device 1200 may implement one or more features and/or methods described herein.

The image processing circuit 1214 may include a feature identifying circuit that includes a Gaussian scale space generator, a feature detector, an image scaling circuit, and/or a feature descriptor extractor. The Gaussian scale space generator may serve to convolve an image with a blurring function to generate a plurality of different scale spaces. The feature detector may then identify one or more keypoints in the different scale spaces for the image (e.g., by using local maxima and minima). The image scaling circuit may serve to approximate the scale of an image in order to select an appropriate kernel size at which to perform feature detection and/or clustering. The feature descriptor generator generates a descriptor for each keypoint and/or its surrounding patch.

According to one exemplary implementation, the speed of searching the descriptor database 1212 may be improved by efficiently arranging or constructing the descriptor database structure. A descriptor database generator 1213 may implement a method to efficiently arrange the descriptor database 1212 as a k-dimensional tree where each node of the tree may be subdivided as a function of the dimensionality of the descriptors and/or the number of descriptors remaining within the node. For instance, a first plurality of descriptors is obtained (e.g., from the image processing circuit 1214) where the first plurality of descriptors fall within a k-dimensional value space. The first plurality of descriptors is divided into a first set of nodes, where the number of nodes in the first set of nodes is a function of the number of descriptors in the first plurality of descriptors and/or the dimensionality of such descriptor (e.g., 2-dimensional, 3-dimensional, k-dimensional, etc.). A second plurality of descriptors in a first node of the first set of nodes may be further subdivided into a second set of nodes, where the number of nodes in the second set of nodes is a function of the number of descriptors in the second plurality of values and/or the dimensionality of such the second plurality of descriptors. This process may be repeated to iteratively subdivide selected nodes until two or fewer descriptors remain in each node.

The image matching circuit 1216 may subsequently attempt to match a query image to one or more images in an image database based on one or more comparisons with the descriptor database 1212. The descriptor database 1212 may include millions of feature descriptors associated with the one or more images stored in the image database 1210.

In some implementations, a set of feature descriptors associated with keypoints for a query image may be received by the device 1200. In this situation, the query image has already been processed to obtain the descriptors. For instance, the device 1200 may be a mobile communication device which may have received the descriptor database 1212 (e.g., over the communication interface 1204). Therefore, such limited-processing resource device need not generate the whole descriptor database 1212. Instead, the mobile communication device may obtain a query image, obtain corresponding descriptors for such query image, and attempts to match the descriptors to those in the descriptor database 1212.

In other implementations, the device 1200 may receive a query image and/or a set of query image descriptors and attempts to match the descriptors with those in the descriptor database 1212.

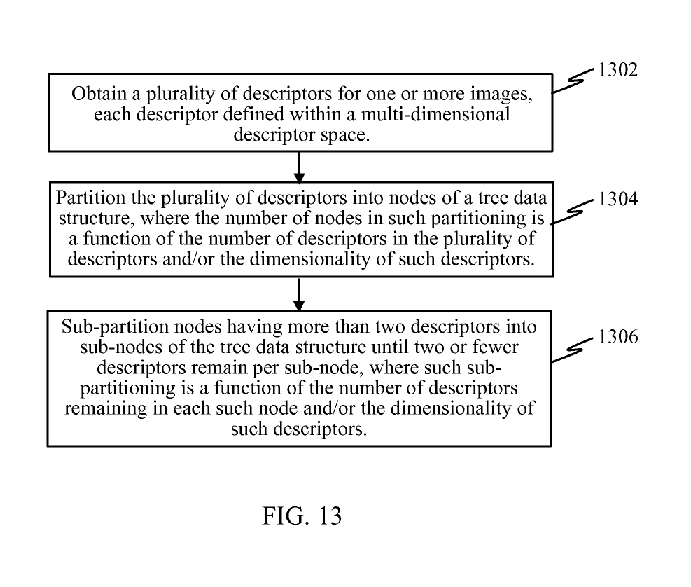

FIG. 13 is a flow diagram illustrating a method for building a descriptor database. Such descriptor database may serve to store, organize, and/or index a plurality of descriptors. A plurality of descriptors may be obtained for one or more images, each descriptor defined within a multi-dimensional descriptor space 1302. That is, one or more images may be processed to identify features and generate the plurality of descriptors (e.g., keypoint descriptors) for such features. The plurality of descriptors are then partitioned into nodes of a tree data structure, where the number of nodes in such partitioning is a function of the number of descriptors in the plurality of descriptors and/or the dimensionality of such descriptors 1304. The dimensionality of the descriptors may refer to the dimensional space (e.g., 2-dimensional, 3-dimensional, 4-dimensional, k-dimensional, . . . ) within which the descriptors are defined. In one example, for an k-dimensional space, a k-th_root function is selected in calculating the partitioning of the plurality of N descriptors (e.g., number of partitions G_{N}=floor (k-th_root(N)+0.5)). Such function may be linear or non-linear. Nodes having more than two descriptors may again be partitioned into sub-nodes of the tree data structure until two or fewer descriptors remain per sub-node, where such partitioning is a function of the number of descriptors remaining in each such node and/or the dimensionality of such descriptors 1306.

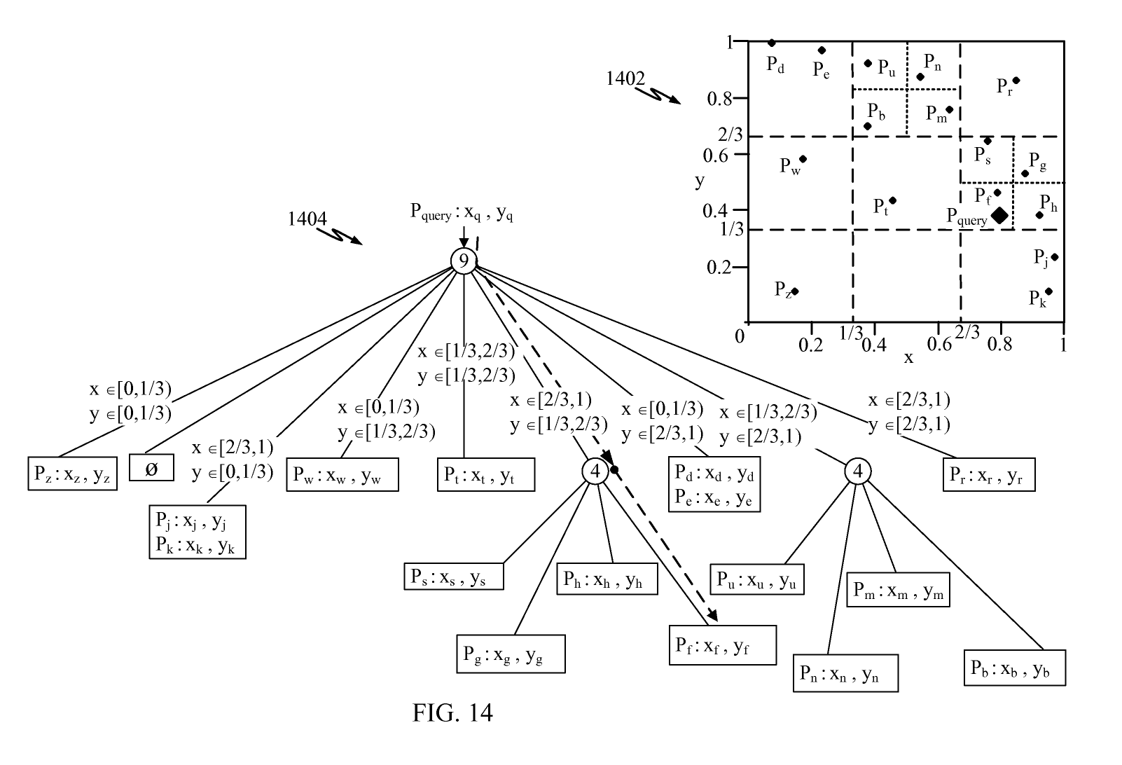

FIG. 14 is a diagram illustrating how a descriptor may be searched in a database constructed from a 2-dimensional k-d tree that maps a plurality of descriptor points to a set of nodes. As illustrated in FIGS. 9, 10, and 11, such tree structure gives a progressively refineable partition of the descriptor or value space. For a plurality of descriptors, represented as points P_{z}, Pⱼ, Pₖ, P_{w}, Pₜ, Pₛ, P_{g}, P_{f}, Pₑ, P_{d}, Pᵤ, Pᵤ, Pₘ, P_{b}, and Pᵣ 1402, corresponding to one or more images, the k-d tree 1404 is constructed as described in FIGS. 9, 10, and 11. In this manner, the k-d tree 1404 may be constructed to represent the descriptors for a plurality of images in a database. This tree structure 1404 may serve as an index to find a closest descriptor.

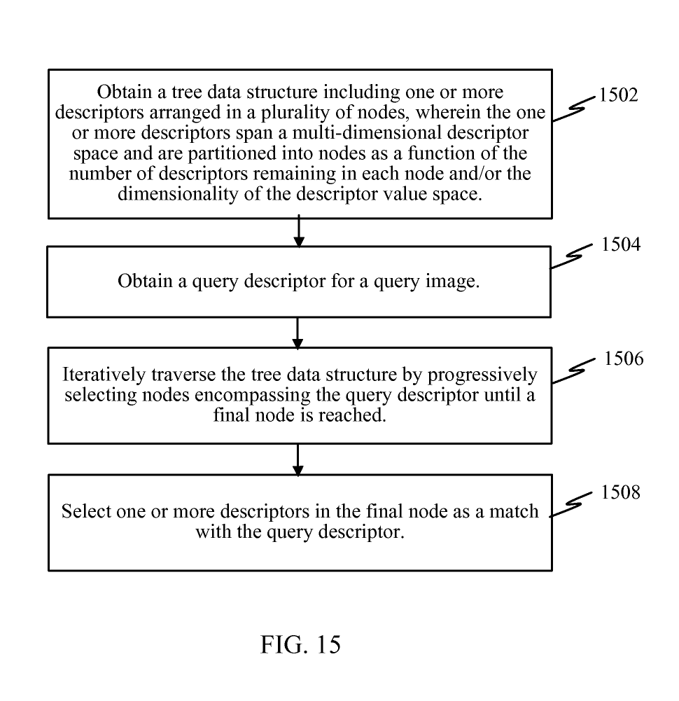

To find a closest match for a query descriptor P_{query}, the query descriptor P_{query} value is iteratively and/or progressively routed through the defined nodes of the tree 1404 until it cannot be routed further (e.g., until a node with the nearest or closest matching points is reached). At each level of the k-d tree, the node into which the query descriptor P_{query} falls is selected. That is, each node may represent a range of the descriptor or value space. Each node may have sub-nodes that further subdivide the range of the descriptor or value space. The query descriptor P_{query} traverses such hierarchical node structure until a node is reached that does not include a more sub-nodes. Any points found in such node (i.e., the final node) may then be considered a match and/or further processing (e.g., geometric consistency checking) may be performed to verify a match. In this example, the query descriptor P_{query}, may be represented by x=0.8, y=0.4 and is therefore placed in the same node as point P_{f}. Consequently, point P_{f} may be the closest match to query descriptor P_{query}. FIG. 15 is a flow diagram illustrating a method for finding a descriptor match in a descriptor database. A tree data structure may be obtained including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space 1502. A query descriptor is then obtained for a query image 1504. The tree data structure is iteratively traversed by progressively selecting nodes encompassing the query descriptor until a final node is reached 1506. That is, the final node is the last node remaining along the traversed path. One or more descriptors in the final node are selected as a match with the query descriptor 1508.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in a figure may be configured to perform one or more of the methods, features, or steps described in another figure. The algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method for generating a descriptor tree data structure, comprising:
obtaining a plurality of descriptors for one or more images, each descriptor defined within a multi-dimensional descriptor space;
partitioning the plurality of descriptors into nodes of a tree data structure, where the number of nodes in such partitioning is a function of the number of descriptors in the plurality of descriptors; and
sub-partitioning nodes having more than two descriptors into sub-nodes of the tree data structure until two or fewer descriptors remain per sub-node, where such sub-partitioning is a function of the number of descriptors remaining in each such node.

2. The method of claim 1, wherein such partitioning and sub-partitioning is also a function of a dimensionality of such descriptors.

3. The method of claim 1, wherein for 2-dimensional descriptors the partitioning and sub-partitioning is based on a square root of the number of descriptors for a particular node.

4. The method of claim 1, wherein for 3-dimensional descriptors the partitioning and sub-partitioning is based on a cubic root of the number of descriptors for a particular node.

5. The method of claim 1, wherein for k-dimensional descriptors the partitioning and sub-partitioning is based on a k-th root of the number of descriptors for a particular node, where k is an integer greater than or equal to four.

6. The method of claim 1, wherein the descriptors are representative of local features in an image.

7. The method of claim 1, wherein the multi-dimensional descriptor space is a bounded, k-dimensional value space, where k is an integer greater or equal to two.

8. The method of claim 1, wherein such partitioning and sub-partitioning is based on a non-linear function.

9. The method of claim 1, for a k-dimensional descriptor space, a number of partitions G_{N} when N descriptors are present is given by G_{N}=floor(kth-root(N)+0.5).

10. The method of claim 1, further comprising:
storing the descriptor tree data structure for subsequent use in descriptor matching.

11. The method of claim 1, further comprising:
obtaining a query descriptor for a query image;
iteratively traversing the tree data structure by progressively selecting nodes encompassing the query descriptor until a final node is reached; and
selecting one or more descriptors in the final node as a match with the query descriptor.

12. A device, comprising:
a storage device for storing a descriptor tree data structure; and
a processing circuit coupled to the storage device, the processing circuit adapted to:
obtain a plurality of descriptors for one or more images, each descriptor defined within a multi-dimensional descriptor space;
partition the plurality of descriptors into nodes of a tree data structure, where the number of nodes in such partitioning is a function of the number of descriptors in the plurality of descriptors; and
sub-partition nodes having more than two descriptors into sub-nodes of the tree data structure until two or fewer descriptors remain per sub-node, where such sub-partitioning is a function of the number of descriptors remaining in each such node.

13. The device of claim 12, wherein such partitioning and sub-partitioning is also a function of a dimensionality of the multi-dimensional descriptor space.

14. The device of claim 12, wherein for k-dimensional descriptors the partitioning and sub-partitioning is based on a k-th root of the number of descriptors for a particular node, where k is an integer greater than or equal to two.

15. The device of claim 12, wherein the multi-dimensional descriptor space is a bounded, k-dimensional value space, where k is an integer greater or equal to two.

16. The device of claim 12, wherein such partitioning and sub-partitioning is based on a non-linear function.

17. The device of claim 12, where for a k-dimensional descriptor space, a number of partitions G_{N} when N descriptors are present is given by G_{N}=floor(kth-root(N)+0.5).

18. The device of claim 12, wherein the processing circuit further adapted to:
obtain a query descriptor for a query image;
iteratively traverse the tree data structure by progressively selecting nodes encompassing the query descriptor until a final node is reached; and
select one or more descriptors in the final node as a match with the query descriptor.

19. A device comprising:
means for obtaining a plurality of descriptors for one or more images, each descriptor defined within a multi-dimensional descriptor space;
means for partitioning the plurality of descriptors into nodes of a tree data structure, where the number of nodes in such partitioning is a function of the number of descriptors in the plurality of descriptors; and
means for sub-partitioning nodes having more than two descriptors into sub-nodes of the tree data structure until two or fewer descriptors remain per sub-node, where such sub-partitioning is a function of the number of descriptors remaining in each such node.

20. The device of claim 19, wherein such partitioning and sub-partitioning is also a function of a dimensionality of such descriptors.

21. The device of claim 19, wherein for k-dimensional descriptors the partitioning and sub-partitioning is based on a k-th root of the number of descriptors for a particular node, where k is an integer greater than or equal to two.

22. The device of claim 19, where for a k-dimensional descriptor space, a number of partitions G_{N} when N descriptors are present is given by G_{N}=floor(kth-root(N)+0.5).

23. The device of claim 19, the processing circuit further adapted to:
means for obtaining a query descriptor for a query image;
means for iteratively traversing the tree data structure by progressively selecting nodes encompassing the query descriptor until a final node is reached; and
means for selecting one or more descriptors in the final node as a match with the query descriptor.

24. A processor-readable medium comprising one or more instructions operational on a device, which when executed by a processing circuit, causes the processing circuit to:
obtain a plurality of descriptors for one or more images, each descriptor defined within a multi-dimensional descriptor space;
partition the plurality of descriptors into nodes of a tree data structure, where the number of nodes in such partitioning is a function of the number of descriptors in the plurality of descriptors; and
sub-partition nodes having more than two descriptors into sub-nodes of the tree data structure until two or fewer descriptors remain per sub-node, where such sub-partitioning is a function of the number of descriptors remaining in each such node.

25. The processor-readable medium of claim 24, further comprising one or more instructions which when executed by the processing circuit, causes the processing circuit to:
obtain a query descriptor for a query image;
iteratively traverse the tree data structure by progressively selecting nodes encompassing the query descriptor until a final node is reached; and
select one or more descriptors in the final node as a match with the query descriptor.

26. A method for descriptor matching, comprising:
obtaining a tree data structure including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space;
obtaining a query descriptor for a query image;
iteratively traversing the tree data structure by progressively selecting nodes encompassing the query descriptor until a final node is reached; and
selecting one or more descriptors in the final node as a match with the query descriptor.

27. The method of claim 26, wherein the plurality of descriptors in the tree data structure are partitioned as a function of a dimensionality of such descriptors.

28. The method of claim 26, wherein for k-dimensional descriptors the partitioning of the plurality of descriptors of the tree data structure is based on a k-th root of the number of descriptors for a particular node, where k is an integer greater than or equal to two.

29. The method of claim 26, further comprising:
obtaining the plurality of descriptors from one or more images to build the tree data structure.

30. The method of claim 26, wherein nodes having more than two descriptors are sub-partitioned into sub-nodes until two or fewer descriptors remain per sub-node, where such sub-partitioning is a function of the number of descriptors remaining in each such node.

31. A device, comprising:
a storage device for storing a descriptor tree data structure; and
a processing circuit coupled to the storage device, the processing circuit adapted to:
obtain a tree data structure including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space;
obtain a query descriptor for a query image;
iteratively traverse the tree data structure by progressively selecting nodes encompassing the query descriptor until a final node is reached; and
select one or more descriptors in the final node as a match with the query descriptor.

32. The device of claim 31, wherein the plurality of descriptors in the tree data structure are partitioned as a function of a dimensionality of such descriptors.

33. The device of claim 31, wherein for k-dimensional descriptors the partitioning of the plurality of descriptors of the tree data structure is based on a k-th root of the number of descriptors for a particular node, where k is an integer greater than or equal to two.

34. The device of claim 31, wherein the processing circuit is further adapted to:
obtain the plurality of descriptors from one or more images to build the tree data structure.

35. The device of claim 31, wherein nodes having more than two descriptors are sub-partitioned into sub-nodes until two or fewer descriptors remain per sub-node, where such sub-partitioning is a function of the number of descriptors remaining in each such node.

36. A device, comprising:
means for obtaining a tree data structure including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space;
means for obtaining a query descriptor for a query image;
means for iteratively traversing the tree data structure by progressively selecting nodes encompassing the query descriptor until a final node is reached; and
means for selecting one or more descriptors in the final node as a match with the query descriptor.

37. The device of claim 36, wherein the plurality of descriptors in the tree data structure are partitioned as a function of a dimensionality of such descriptors.

38. The device of claim 36, wherein for k-dimensional descriptors the partitioning of the plurality of descriptors of the tree data structure is based on a k-th root of the number of descriptors for a particular node, where k is an integer greater than or equal to two.

39. A processor-readable medium comprising one or more instructions operational on a device, which when executed by a processing circuit, causes the processing circuit to:
obtain a tree data structure including one or more descriptors arranged in a plurality of nodes, wherein the one or more descriptors span a multi-dimensional descriptor space and are partitioned into nodes as a function of the number of descriptors remaining in each node and/or the dimensionality of the descriptor value space;
obtain a query descriptor for a query image;
iteratively traverse the tree data structure by progressively selecting nodes encompassing the query descriptor until a final node is reached; and
select one or more descriptors in the final node as a match with the query descriptor.

40. The processor-readable medium of claim 39, wherein the plurality of descriptors in the tree data structure are partitioned as a function of a dimensionality of such descriptors.

41. The processor-readable medium of claim 39, wherein for k-dimensional descriptors the partitioning of the plurality of descriptors of the tree data structure is based on a k-th root of the number of descriptors for a particular node, where k is an integer greater than or equal to two.
